(19) United States
(12) Patent Application Publication
(10) Pub. No.: US 2002/0087517 A1
(43) Pub. Date: Jul. 4, 2002

(54) Enhanced method and system for storing and managing search criteria

(76) Inventor: Scott S. Lawton, Chelmsford, MA (US)

Correspondence Address: FOLEY, HOAG & ELIOT, LLP, PATENT GROUP, ONE POST OFFICE SQUARE, BOSTON, MA, 02109, US

(21) Appl. No.: 09/969,012

(22) Filed: Oct. 2, 2001

Related U.S. Application Data
(60) Provisional application No. 60/238,577, filed on Oct. 6, 2000.
(60) Provisional application No. 60/238,791, filed on Oct. 6, 2000.
(60) Provisional application No. 60/238,587, filed on Oct. 6, 2000.
(60) Provisional application No. 60/238,754, filed on Oct. 6, 2000.
(60) Provisional application No. 60/237,249, filed on Oct. 2, 2000.
(60) Provisional application No. 60/237,254, filed on Oct. 2, 2000.
(60) Provisional application No. 60/237,250, filed on Oct. 2, 2000.
(60) Provisional application No. 60/237,252, filed on Oct. 2, 2000.
(60) Provisional application No. 60/237,243, filed on Oct. 2, 2000.

(51) Int. Cl. G06F 7/00

(52) U.S. Cl. 707/2

(57) ABSTRACT

An enhanced method and system for storing and managing search criteria, streamlining the process by eliminating one step and integrating other innovations to increase user convenience. This invention reduces the time and frustration associated with repeated searches, by reducing the time required to store, review, edit, delete and invoke search criteria.

### COPYRIGHT NOTICE

The following patent disclosure includes material that is subject to copyright protection. The copyright owner has no objection to the facsimile reproduction of the disclosure by any person as it appears in the records of the U.S. Patent and Trademark Office, but otherwise reserves all rights to the copyright whatsoever.

### FIELD OF THE INVENTION

The invention relates generally to information retrieval from data repositories, and more particularly to an enhanced method and system for storing search criteria and managing the stored search criteria, whereby the user spends less time and effort on repetitive searches.

### BACKGROUND OF THE INVENTION

As a society, we are increasingly becoming both dependent on and overloaded with information, especially data that is stored in computer databases or full-text collections. As the quantity of information stored in these data repositories increases, the complexity of retrieving relevant information also increases. To locate information, users search general collections (e.g., AltaVista, Excite, InfoSeek, Lycos, Yahoo, etc.) as well as specialized sources which may be implemented with back-end databases, such as those dedicated to locating employment opportunities (e.g., CareerBuilder, CareerPath, Headhunter.net, HotJobs, Monster.com, etc.). According to recent studies from technology analysts (e.g., the Jupiter Group and Forrester Research), Internet searching is the most common online activity next to sending/receiving e-mail communications.

Data repositories may take on several forms, including relational databases, hierarchical databases, and flat-file databases, all of which support and may require searching within specific fields or columns, full-text collections which may or may not support searching within fields or delimited portions of documents that are represented as fields, and/or one or more documents. As used herein, the term “data element” refers to a database field, a delimited portion of a document, meta information associated with a document, or to an entire document. As used herein, the term “data object” refers to a database record, a document, or some other grouping of associated data elements. As used herein, the term “data unit” refers to the value or contents of a data element. As used herein, the term “page” refers to a document or page on the World Wide Wide or other public or private network, e.g. a continuously scrollable body of information which may or may not include so-called “frames,” (i.e. portions that do not scroll automatically when other portions of the page are scrolled). As used herein, the term “query” will be used as a synonym for the phrase “search criteria.”

Although many searches are “ad hoc,” using completely different search criteria for each visit, other searches are likely to use similar or even identical search criteria on subsequent visits. Examples include searching job openings, resumes of job seekers, apartments for rent, houses for sale, etc. Most search Web sites force users to enter search criteria from scratch each time, wasting time and increasing frustration.

To address these problems, some search Web sites let you save search criteria by name and recall the named search criteria in a subsequent visit. Although useful, the current generation of these sites have a number of limitations. For example, Monster.com includes a “Save Search as an Agent” checkbox on the search page and StartupNetwork.com includes a “Save Search” button on the result list, but both present an additional form requesting search criteria and other information, imposing an extra step on the job seeker.

In summary, the prior art does not provide effective and convenient ways to quickly store, review, edit, delete and invoke search criteria.

### SUMMARY OF THE INVENTION

In the present invention, a computer with appropriate software enables a user to store and manage search criteria.

The present invention overcomes prior art limitations by streamlining the process, eliminating one step and integrating other innovations to increase user convenience.

It is an object of the invention to reduce the time and frustration associated with repeated searches, by reducing the time required to store, review, edit, delete and invoke search criteria.

Other objects and advantages of the invention will, in part, be obvious, and, in part, be shown from the following description.

### BRIEF DESCRIPTION OF THE DRAWINGS

FIG. 1 is a schematic representation depicting the components of one embodiment of the invention;

FIGS. 2a and 2b depict illustrative embodiments of the interface for the result list and query list;

FIG. 3 is a flow chart depicting the steps for one illustrative embodiment of the invention;

FIG. 4 is a schematic representation depicting one illustrative embodiment of the invention, wherein the invention is coupled to a network;

FIG. 5 is a schematic representation depicting one illustrative embodiment of the invention, wherein the invention interacts with a single electronic device.

### LIST OF REFERENCE NUMERALS

10 system components

12 first controller

14 result input port

16 secondary input port

18 merged output port

20 storage

22 second controller

24 name input port

26 identifier input port

28 summary output port

30 computer

50 system with network

52A-52C IADs

54A-54C Web browsers

56 network

58 HTTP Web server

62 search engine

64 data repository

68 server computer

90 system with single electronic device

### DESCRIPTION OF THE ILLUSTRATIVE EMBODIMENTS

To provide an overall understanding of the invention, certain illustrative embodiments will now be described. However, it will be understood by one of ordinary skill in the art that the methods and systems described herein may be adapted and modified for other suitable applications and that such other additions and modifications will not depart from the spirit and scope of the inventive concept.

To more clearly and concisely describe the subject matter of the invention, the following definitions are intended to provide guidance as to the meaning of specific terms used in the following written description, examples, and appended claims. As used herein, the term or phrase:

“communications network” and “network” include a LAN, a MAN, a WAN, an Intranet, an Extranet, the Internet, a wireless network (e.g., according to the WAP protocol), and the like;

“Information Location Mechanism” (hereinafter “ILM”) includes software, firmware and/or systems capable of searching a data repository to locate information that meets search criteria, such systems including database management systems, search engines supporting full-text search, search engines supporting fielded search, search engines supporting regular expressions and/or other patterns, and/or iterative search engines;

“Information Sorting Mechanism” (hereinafter “ISM”) includes software, firmware and/or systems capable of ordering data objects according to sort criteria, such systems including database management systems, text processing library routines, etc.;

“Internet Access Device” (hereinafter “IAD”) includes personal computer systems (hereinafter “PCs”), computer workstations, desktop computers, laptop computers, hand-held computers, television set-top boxes, wireless access devices such as mobile telephones, cellular telephones, pagers, beepers, and other various hand-held wireless devices, and all other devices that have at least one processor, UD and VDU, and are capable of accessing the Internet and/or other networks;

“processor” includes all components, devices, Integrated Circuits (hereinafter “ICs”), modules, software, subsystems, and/or systems that provide control and/or perform arithmetic and logical operations and/or extract computer instructions and/or decode computer instructions and/or execute computer instructions, such as a Central Processing Unit (hereinafter “CPU”), a microprocessor, a controller, and the like; including any associated memory or other electronic storage of data and/or instructions;

“User-input Device” (hereinafter “UD”) includes keyboards, keypads, mice, trackballs, trackpads, wheels, joysticks, graphics tablets, voice recognition devices, motion sensing devices and other devices for one or more users to enter text, numbers or other data and/or for pointing, clicking, tapping, selecting, dragging and/or other gestures or actions;

“Visual Display Unit” (hereinafter “VDU”) includes CRT screens, monitors, video display terminals, LCD screens, LED screens, digital paper, and all other devices that are capable of displaying analog or digital data;

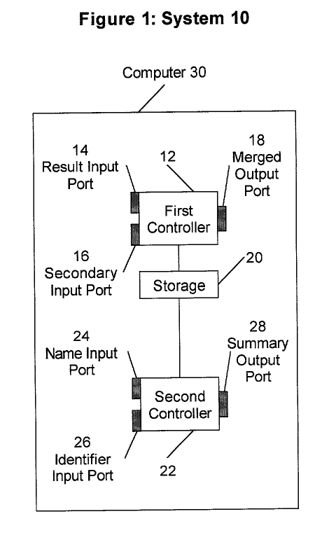

FIG. 1 depicts an illustrative embodiment of one system 10 according to the invention which stores and manages search criteria. The system comprises a first controller 12 containing a result input port 14, a secondary input port 16 and a merged output port 18. The first controller 12 is coupled with storage 20, which is in turn coupled with a second controller 22 containing a name input port 24, an identifier input port 26 and a summary output port 28.

For this illustrative embodiment, the first controller 12 with ports 14, 16 and 18, the storage 20 and the second controller 22 with ports 24, 26 and 28 reside on a single computer 30 which may be a Macintosh G3 running MacOS 8.5. For this illustrative embodiment, the first controller 12 and the second controller 22 are coded in the UserTalk language embedded in UserLand Frontier, a commercial scripting and Web development system. For this illustrative embodiment, storage 20 is an object database in UserLand Frontier.

It will be readily apparent to those skilled in the art that the computer 30 could be a different Macintosh computer running a different version of MacOS or a different OS such as Linux, or an Intel or Intel-compatible PC or server running a version of the Microsoft Windows operating system such as Windows 98, Windows NT or Windows 2000, or an Intel or Intel-compatible PC or server running Linux or FreeBSD or other UNIX OS, or a computer from Sun, HP, IBM or other company, running Solaris, HP-UX, AIX or other variation of UNIX or other OS.

It will be readily apparent to those skilled in the art that the functions performed in this embodiment with a single computer 30 could be divided among a plurality of computers from the same or different manufacturers, with each computer running the same or different operating systems.

It will be readily apparent to those skilled in the art that first controller 12 and/or second controller 22 could be coded in any suitable scripting or programming language such as Perl, JavaScript, Java, VBScript, Visual BASIC, C++, etc. or any suitable Web development system such as Vignette StoryServer, Allaire ColdFusion, SilverStream, etc., and that first controller 12 and second controller 22 need not be coded in the same language or system.

It will be readily apparent to those skilled in the art that storage 20 could be implemented with a file or files stored on a computer-readable medium, with a database management system, or using other well-known storage techniques.

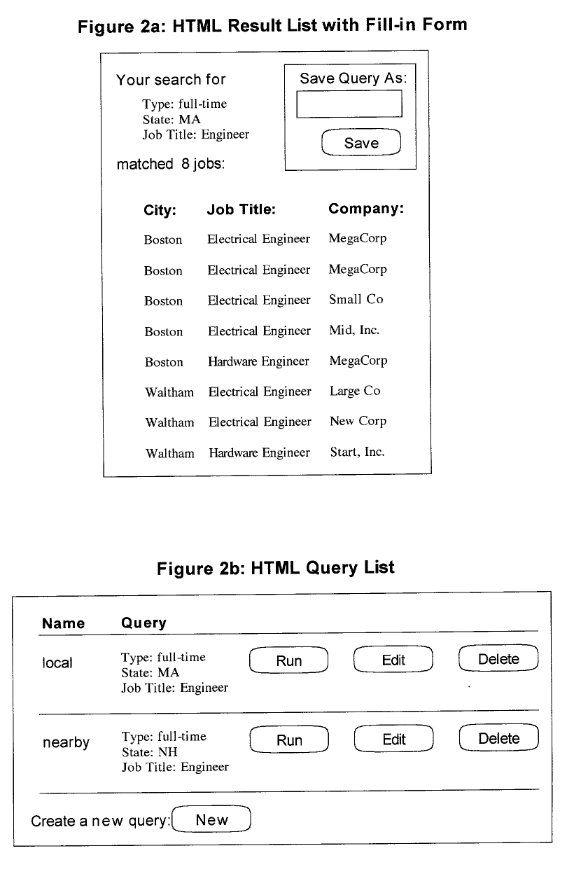

FIG. 2a depicts one illustrative embodiment of the result list as an HTML page with a fill-in form. In this embodiment, the result list page is comprised of a label “Your search for,” a list of labelled search criteria such as “Type: full-time/State: MA/Job Title: Engineer” presented as one line per field/value pair, text indicating the number of jobs matched, such as “matched 8 jobs,” a header row with the labels “City,” “Job Title,” and “Company,” followed by one row for each job, with each row listing the city, job title, and company; and a fill-in form. In this embodiment, the fill-in form is comprised of a label “Save Query As,” a text entry box, and a button labelled “Save.”

With this embodiment of the invention, users can enter a query name and store any query directly from the result list page with no additional page required. To further reduce the required effort, the invention may also be configured to pre-fill a value into the text entry box, e.g. based on the name of a query that was run to display this result list, on one or more elements of the query, on a number relative to the total stored queries, or otherwise. With this embodiment of the invention, users see the full query text on the result list page; aiding them in understanding the scope and content of the results and clearly showing what search criteria will be stored.

FIG. 2b depicts one illustrative embodiment of the query list as an HTML page. In this embodiment, the result list page is comprised of a row with two labels “Name” and “Query,” followed by a row for each saved query separated by a horizontal line for each, with each row listing the query name, the search criteria, and three action buttons labelled “Run,” “Edit,” and “Delete.” In this embodiment, the set of query rows is followed by a row containing a label “Create new query” and a button labelled “New.”

With this embodiment of the invention, users can see at a glance the entire search criteria in addition to the query name. Users can also create a new query without leaving the page. The invention may be configured to, upon the user activating the “Edit” button, fill the search criteria into the standard search form so that users save time and reduce the effort required to learn the system by using one form for creating and editing search criteria.

It will be readily apparent to those skilled in the art that either interface could vary in many ways, such as by omitting certain elements (e.g. the search criteria) or adding other elements, arranging the elements in a different manner on the page, etc.

It will be readily apparent to those skilled in the art that either interface could be modified to apply to other domains, e.g. with data elements such as “Skills” to search resumes of job seekers, or “Amenities” to search apartments for rent, or “Location” to search houses for sale, etc.

It will be readily apparent to those skilled in the art that the interface could be presented in many fashions, e.g. as an XML fill-in form, a PDF fill-in form, a form implemented in a Java applet or Active X control, a form implemented using desktop or client-server software, or otherwise.

### OPERATION

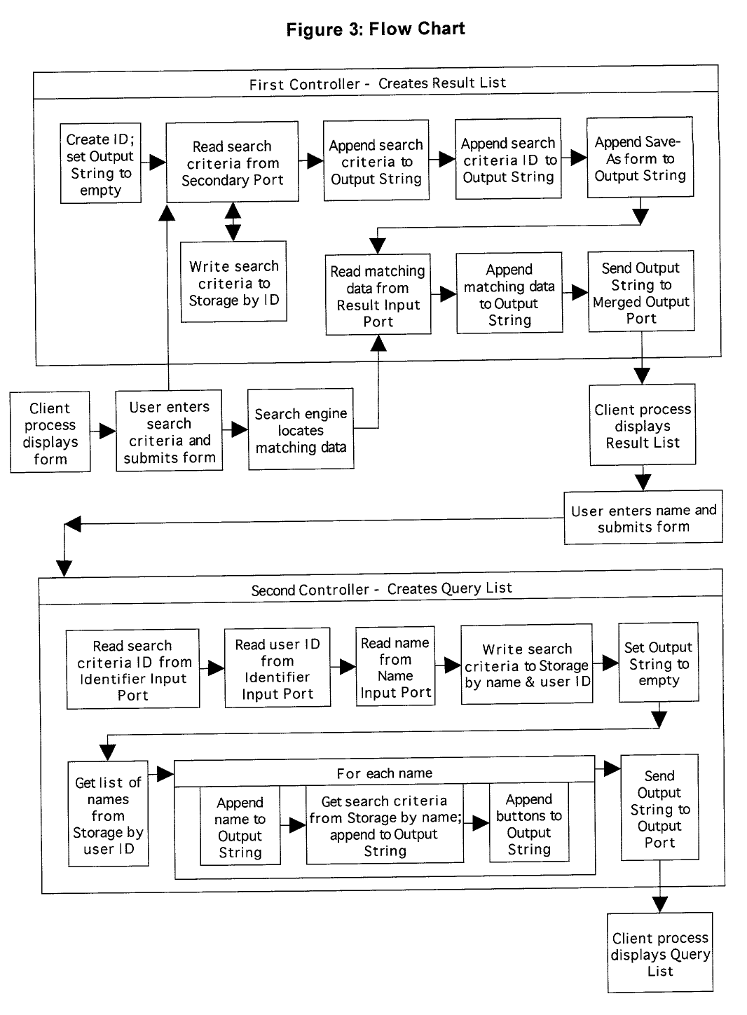

FIG. 3 is a flow chart that depicts one sequence of operation for this illustrative embodiment. Initially, a client process displays a search form to the user, whereupon the user enters search criteria and submits the form to a search engine, which locates matching data. The first controller 12 creates a query identifier (“ID”) and sets a variable called Output String to empty, reads the search criteria from secondary port 16, writes the search criteria to storage 20 by ID, appends the search criteria, search criteria ID and the Save-As form to the Output String. The first controller 12 the reads matching data from result input port 14 and appends the matching data to the Output String, then sends the Output String to merged output port 18 for subsequent display by the client process.

If the user chooses to store the search criteria from the displayed result list via the fill-in form, the user enters a name for the query and submits the form. Second controller 22 receives the query ID and user ID from identifier input port 26, reads the name from name input port 24 and writes the query to Storage 20 by name and user ID. Second controller 22 then sets the Output String to empty, gets a list of names from Storage 20 by user ID, and, for each name, appends the name to the Output String, reads the query from Storage 20 by name and user ID and appends the query to the Output String, then appends the action buttons to the Output String. Second controller 22 then sends the Output String to summary output port 28 for subsequent display on the client process.

It will be readily apparent to those skilled in the art that the same result could be accomplished with variations on these two sequences, such as reading matching data prior to the search criteria or reading the name prior to the ID. It will be further apparent that by keeping different data in storage, the inputs could vary somewhat, such as by first controller 12 storing the user ID according to the search criteria ID and second controller 22 reading the user ID from Storage rather than from the identifier input port 26. It will be further apparent that first controller 12 and second controller 22 could accept and process information in a variety of formats, each of which may differ from the other.

### ALTERNATIVE EMBODIMENTS

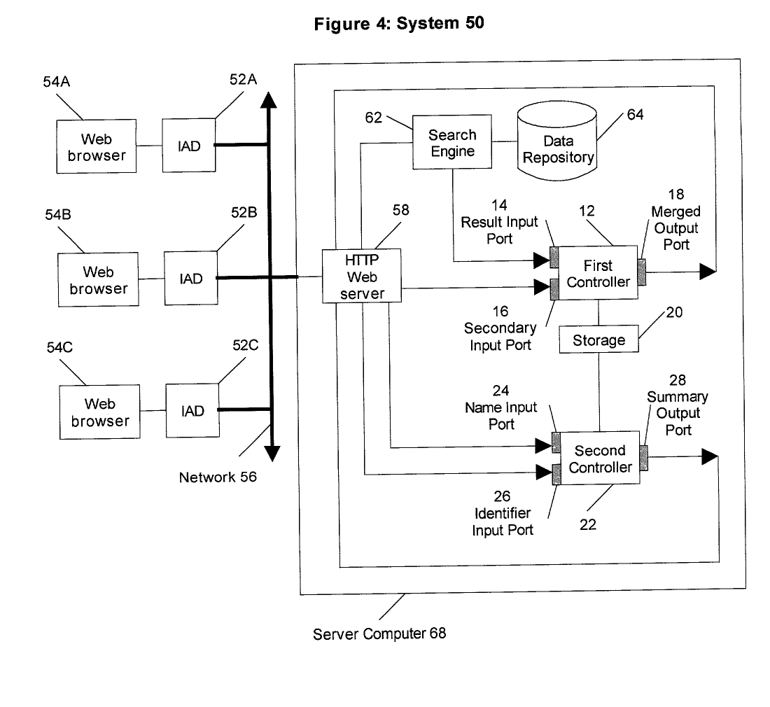

FIG. 4 depicts another illustrative embodiment of one system 50 according to the invention which stores and manages search criteria provided over a network. The system comprises a plurality of IADs 52A-52C, each integrated with or coupled to a client process such as a Web browser 54A-54C and coupled to a network 56, which is in turn coupled to an HTTP Web server 58, which is coupled to search engine 62, which is in turn coupled to data repository 64 and to first controller 12 via result port 14. The first controller 12 is also coupled to HTTP Web server 58 via secondary input port 16, and coupled via merged output port 18 to HTTP Web server 58 in order to return the merged result list page with fill-in form to the IADs 52A-52C to display for the users on client processes such as Web browsers 54A-54C.

The first controller 12 is coupled with storage 20, which is in turn coupled with a second controller 22 containing a name input port 24 and an identifier input port 26 which are coupled to HTTP Web server 58. The second controller 22 is coupled via summary output port 28 to HTTP Web server 58 in order to return the query list to the IADs 52A-52C to display for the users on client processes such as Web browsers 54A-54C.

For this illustrative embodiment, the HTTP Web server 58, search engine 62, data repository 64, first controller 12 with ports 14, 16 and 18, storage 20, and second controller 22 with ports 24, 26 and 28, reside on a single server computer 68.

It will be readily apparent to those skilled in the art that the functions performed in this embodiment with a single server computer 68 could be divided among a plurality of server computers from the same or different manufacturers, with each computer running the same or different operating systems.

It will be readily apparent to those skilled in the art that the HTTP Web server 58 could be WebStar, WebTen, Microsoft IIS, Apache or other commercial or open source Web server or Web development system, such as UserLand Frontier, which includes a built-in Web server. It will be readily apparent to those skilled in the art that first controller 12, second controller 22, and other components could interact with HTTP Web server 58 via CGI, plug-in, servlets, Enterprise Java Beans, etc.

It will be readily apparent to those skilled in the art that search engine 62 and data repository 64 could be any suitable database management system such as Oracle, Informix, Sybase, SQL Server, Access, mySQL, PostgreSQL, etc. or full-text search engine and associated collection or other index mechanism such as those provided by Verity, UltraSeek, Thunderstone, etc., and/or other software capable of storing and searching data. It will be further apparent that search engine 62 and data repository 64 need not be implemented using the same software nor even reside on the same computer.

### OPERATION

The user controls one or more UDs to enter and/or select search criteria in an HTML form via a Web browser 54 running on an IAD 52. The Web browser 54 sends the criteria over the network 56 via the HTTP protocol to the HTTP Web server 58 running on the server computer 68, which forwards the search criteria to search engine 62 and to secondary input port 16 of first controller 12. Search engine 62 locates matching data in data repository 64 and sends the data to first controller 12 via result input port 14. First controller 12 writes the search criteria to storage 20 then sends the search criteria, matching data and a name fill-in form as an HTML page via merged output port 18 to HTTP Web server 58, which returns the HTML page over the network 56 via the HTTP protocol back to the user's Web browser 54 which displays it on the VDU of IAD 52.

If the user enters a name and clicks the “Save” button using the UD, Web browser 54 running on an IAD 52 sends the name, embedded query ID and a user ID via the HTTP protocol to HTTP Web server 58. Second controller 22 reads the name via the name input port 24 and the query ID and user ID via identifier input port 26, writes the search criteria by name and user ID, assembles the query list as an HTML page by reading from storage 20 by name and user ID, then sends the query list via summary output port 28 to HTTP Web server 58, which returns the HTML page over the network 56 via the HTTP protocol back to the user's Web browser 54 which displays it on the VDU of IAD 52.

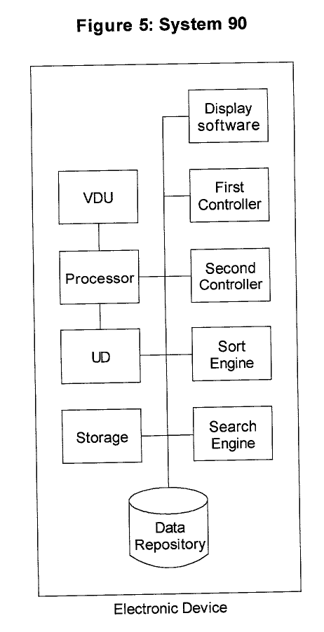

FIG. 5 depicts an illustrative embodiment of one system 90 according to the invention. The system comprises a single electronic device with at least one processor, at least one UD, at least one VDU and some form of storage, with the system 90 running software configured as one or more components to display a search form, accept user input, store the user input using first controller 12, perform a search on a local or embedded data repository, sort the results, return the results to the user with a name fill-in form, accept a form request from the user, store the new name and read previously stored values using second controller 22 into a query list, and returning the list to display for the user.

It will be readily apparent to those skilled in the art that, as depicted in FIG. 5, the first controller 12 and/or second controller 22 may have direct access to storage 20 and/or to search engine 62 and/or to data repository 64 and/or to a sort engine, reading the data from one or more locations according to the particular embodiment. It will be further apparent from FIG. 5 that search engine 62, data repository 64 and the sort engine have direct access to each other, such that any could access data on behalf of any other component according to the particular embodiment.

It will be readily apparent to those skilled in the art that one or more of the depicted individual components could be moved to a different device, situated locally or remotely, to, for example, support a remote data repository or have certain functions performed remotely.

As previously indicated, those skilled in the art will know or be able to ascertain using no more than routine experimentation, many equivalents to the illustrative embodiments and practices described herein. It will also be understood that the methods and systems described herein provide advantages over the prior art by eliminating one step and integrating other innovations, reducing the time and frustration associated with repeated searches. Accordingly, the scope of the invention should be determined not by the embodiments disclosed herein, but by the following claims, which are to be interpreted as broadly as allowed under the law.

Furthermore, it is to be understood that the terminology used herein is for the purpose of describing particular illustrative embodiments only and is not intended to be limiting. It must be noted that as used herein, including the appended claims, the singular forms “a,” “an,” and “the” include plural referents unless the context clearly dictates otherwise.

What is claimed is:

1. A Query Management System (QMS) for storing search criteria directly from a search result list, the QMS comprising:
a result input port configured to receive a result list of one or more data objects from an Information Location Mechanism (ILM);
a secondary input port configured to receive search criteria and/or a session identifier and/or a user identifier;
a merged output port configured to send the result list and an action trigger that will invoke the second controller, and at least one identifier to a Visual Display Unit (VDU) and/or to the mechanism that invoked the QMS;
a storage mechanism;
an identifier input port configured to receive a user identifier and/or search criteria identifier;
a secondary output port configured to send a reply to the user;
a first controller configured to:
receive data from the result input port,
receive data from the secondary input port, and
send data to the merged output port;
a second controller configured to:
receive data from the identifier input port,
write data to the storage mechanism, and
send data to the secondary output port;
whereby the user can store search criteria with minimum time and effort, making repeated searches faster and easier.

2. The QMS recited in claim 1 wherein the first controller is configured to receive search criteria from the secondary input port, and to send the search criteria as its own identifier to the merged output port; and wherein the second controller is configured to receive the search criteria from the identifier input port.

3. The QMS recited in claim 1 wherein the first controller is configured to receive search criteria and a session identifier from the secondary input port, and to write the search criteria to storage by the session identifier; and wherein the second controller is configured to receive the session identifier from the identifier input port.

4. The QMS recited in claim 1 wherein the first controller is configured to create a session identifier rather than receiving it.

5. The QMS recited in claim 1 wherein the first controller is configured to receive a user identifier from the secondary input port, and to write the search criteria to storage by the user identifier, and to send the user identifier to the merged output port; and wherein the second controller is configured to receive the user identifier from the identifier input port.

6. The QMS recited in claim 1 wherein the first controller is configured to receive a session identifier from the secondary input port, and to write the search criteria to storage by the session identifier, and to send the session identifier to the merged output port; and wherein the second controller is configured to receive the session identifier and a user identifier from the identifier input port, and to write the user identifier to storage with the search criteria indicated by the session identifier.

7. The QMS recited in claim 1 wherein the first controller is configured to receive a session identifier from the secondary input port, and to write the search criteria to storage by the session identifier, and to send the session identifier to the merged output port; and wherein the second controller is configured to receive the session identifier and a user identifier from the identifier input port, and to copy or move the search criteria associated with the session identifier to an area of storage associated with the user identifier.

8. The QMS recited in claim 1, further including a name input port configured to receive a user-visible identifier for the search criteria and wherein the second controller is configured to receive the user-visible identifier and write it to storage with the search criteria.

9. The QMS recited in claim 9 wherein the first controller generates a user-visible identifier from the search criteria.

10. The QMS recited in claim 9 wherein the first controller receives a user identifier and generates a user-visible identifier based on the number of search criteria stored by the user.

11. The QMS recited in claim 9 wherein the first controller generates a text entry field in association with the action trigger.

12. The QMS recited in claim 1 wherein the second controller is configured to return a status message to the secondary output port.

13. The QMS recited in claim 1 wherein the second controller is configured to return the newly stored search criteria to the secondary output port.

14. The QMS recited in claim 1 wherein the second controller is configured to receive a user identifier from the identifier input port, and read from storage every search criteria stored by the user, then return a list of search criteria to the secondary output port.

15. The QMS recited in claim 15 wherein the returned list includes the user-specified identifier for each stored search criteria.

16. The QMS recited in claim 15 wherein the returned list includes the stored search criteria.

17. The QMS recited in claim 15 wherein the returned list is merged with a search form.

18. The QMS recited in claim 1 wherein the user identifier and/or search criteria identifier is derived from at least one of the following:
a Web “cookie”,
HTTP authentication,
a parameter in an HTML form, and/or
Windows NT authentication.

19. The QMS recited in claim 1 wherein the action trigger is a button labelled “Save,” “Store” or similar word or phrase in English or other language.

20. The QMS recited in claim 1 wherein the result list and/or action trigger employs a markup language including HTML, XML and/or SGML.

21. The QMS recited in claim 1 wherein the result list and/or action trigger employs a portable document format.

22. The QMS recited in claim 1 wherein the result list and/or action trigger employs script and/or program code.

23. The QMS recited in claim 1 wherein the result input port, the secondary input port, the merged output port, the storage mechanism, the identifier input port, and/or the secondary output port is/are coupled to an HTTP Web server, or coupled to a computer-readable media, or configured to communicate via a standard electronic messaging protocol.

24. The QMS recited in claim 1 wherein the ILM is a database management system, a search engine supporting full-text search, a search engine supporting fielded search, a search engine supporting regular expressions and/or other patterns, and/or an iterative search engine.

25. The QMS recited in claim 1 wherein the search criteria includes at least one data element of employment information.

26. A search system comprising:
a QMS as recited in claim 1;
an ILM coupled to a data repository containing a plurality of data objects, the ILM being configured to receive the search criteria in a predetermined syntax, search the data repository, and retrieve zero or more data objects that conform to the search criteria;
a formatting engine configured to format the search results from the ILM; and
a client process and VDU to display the search form, the formatted search results and the action trigger.

27. The search system recited in claim 27 wherein the search form employs a markup language such as HTML, XML or SGML.

28. The search system recited in claim 27 wherein the contents of at least one data element of at least one data object include employment information.

29. The search system recited in claim 27, further including:
sort port configured to receive sort criteria;
an Information Sorting Mechanism (ISM) coupled between the ILM and the formatting engine; the ISM being configured to receive the sort criteria in a predetermined syntax, receive a plurality of data objects from the ILM, sort the data objects according to the sort criteria, and forward the sorted data objects to the formatting engine.

30. A query management method for storing search criteria directly from a search result list, the method comprising:
receiving a result list of one or more data objects from an Information Location Mechanism (ILM),
receiving search criteria and/or a session identifier and/or a user identifier, and
sending the result list and an action trigger, and at least one identifier to a Visual Display Unit (VDU) and/or to the mechanism that invoked the method; then subsequently
receiving a user identifier and/or search criteria identifier,
writing data to a storage mechanism, and
returning data to the mechanism that invoked the method;
whereby the user can store search criteria with minimum time and effort, making repeated searches faster and easier.
